(19) United States
(12) Patent Application Publication
(10) Pub. No.: US 2010/0309084 A1
(43) Pub. Date: Dec. 9, 2010

(54) Bi-Polarized Broadband Radiation Unit of Annular Type and Linear Array Antenna

(75) Inventors: Binlong Bu, Guangzhou City (CN); Peitao Liu, Guangzhou City (CN); Shanqiu Sun, Guangzhou City (CN); Songdong Fan, Guangzhou City (CN); Xiaobing Su, Guangzhou City (CN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: COMBA TELECOM SYSTEM (CHINA) LTD., Guangzhou City (CN)

(21) Appl. No.: 12/740,785

(22) PCT Filed: Aug. 1, 2008
(86) PCT No.: PCT/CN08/01407

§ 371 Date: Aug. 17, 2010

(30) Foreign Application Priority Data
Oct. 30, 2007 (CN) 200710031144.3

(51) Int. Cl. H01Q 21/08

(52) U.S. Cl. 343/824

(57) ABSTRACT

A broadband radiation unit includes first and second pairs of symmetric dipoles operable to transmit communication signals and to receive communication signals. The first pair of symmetric dipoles has a polarization that is orthogonal to that of the second pair of symmetric dipoles. The first and second pairs of symmetric dipoles together define an annular structure. A plurality of baluns are associated with the first and second pairs of symmetric dipoles such that a given one of the baluns is associated with a respective symmetric dipole of the pairs of symmetric dipoles. Each one of the baluns feeds a balanced current to its associated symmetric dipole. Each symmetric dipole of the first and second pairs of symmetric dipoles has two unit arms which are disposed on and arranged symmetrically about its associated balun.

### FIELD OF THE INVENTION

The invention relates to antennas used in mobile communications and more particularly, to a bi-polarized broadband radiation unit of annular type with minimized volume and to a linear array antenna incorporating such bi-polarized broadband radiation unit.

### BACKGROUND OF THE INVENTION

With advances in telecommunications technology, 2G and 3G networks are expected to co-exist for a long time. To meet the coverage requirement of such different communication networks, more rigorous quality requirements are required for mobile telecommunication systems. In particular, a broadband antenna capable of operating in both the 2G frequency band and the 3G frequency band is strongly desired.

To optimize networks of various communication systems, the antennas used must provide a high precision horizontal beam width. Lobe-shaping should also be taken into account in designing the elevation pattern to suppress the upper side lobe and to realize zero filling of the lower side lobe, thereby attaining more reliable communication quality. Furthermore, polarization diversity technology has been applied to antennas of base stations to eliminate multi-path fading, thus also greatly improving communication quality.

Base station antennas are important outside components of mobile telecommunication systems. Presently, bi-polarization is a major polarization diversity of such base stations. The bi-polarized antennas mainly include those polarized by an angles of ±45°, which mostly include antennas having a horizontal beam width of 65°. The performance of this kind of antenna (with the horizontal beam width of 65°) directly impacts the coverage and polarization diversity gain of the mobile telecommunication systems and therefore impacts working performance of the entire network.

A conventional bi-polarized base station antenna with a polarization angle of ±45° is constructed either of radiation units provided with symmetric dipoles or of micro-strip radiation units. The relative operating frequency of this kind of antenna with high cross polarization discrimination is less than 10%, thus influencing the correlation between +45° antenna and −45° antenna and influencing diversity efficiency of the antenna working at a wide frequency range. The value of the cross polarization discrimination also influences the separation between output ports. Further, the gain of the antenna is decreased, the switch time in margin regions is increased, and the communication quality of the network deteriorates due to wide horizontal half power beam width of the symmetric dipole radiation unit. In addition, the working frequency range of a conventional symmetric dipole antenna is only about 13%. Moreover, antennas constructed of microstrip radiation units have an even narrower frequency range of no more than 10%.

A radiation unit is disclosed in U.S. Pat. No. 4,434,425, assigned to GTE Products Corporation and published in 1984, the disclosure of which is incorporated by reference herein. The patent shows a solution to the above issue, in which the high frequency dipole is incorporated into the low frequency dipole, as illustrated in FIG. 1. The combination of the low-frequency antenna radiation unit with the high frequency antenna radiation unit shows a way to realize small-sized, multiple frequency community base station antennas.

A multiple frequency community base station antenna used in mobile communication system is described in U.S. Pat. No. 6,333,720 B1, issued to the German company Kathrein and published in 2001, the disclosure of which is incorporated by reference herein, and is shown in FIG. 2. The apparent interrelationship among the radiation units is the same as that disclosed in U.S. Pat. No. 4,434,425.

However, the radiation units described in both of the above patents suffer from various drawbacks, such as a large frontal projected area and a complicated construction. Additional drawbacks are set forth below.

Firstly, high frequency radiation performance deteriorates due to the coupling effect of the two low frequency dipoles on the high frequency dipole when located between the two low frequency dipoles.

Secondly, if restricted control of the vertical grating lobe of a multiple frequency electronically adjustable base station antenna is required for the communication system, then the pitch between the radiation units is reduced, thus causing more significant coupling between the two low frequency dipoles as well as between the low and high frequency dipoles. In some cases, this coupling is unacceptable and causes great damage to the circuitry and radiation characteristics of the antenna.

Multiple frequency community base station antennas commonly have no high frequency dipole incorporated into the low frequency dipole. By contrast, a low frequency dipole having high frequency dipole included therein has a significantly different impedance performance than a low frequency dipole that does not have such a high frequency dipole contained therein.

Accordingly, the technical evolution of the radiation unit is very complicated, though its design seems simple physically. It is therefore desired to balance the relationship between size and electrical performance, i.e., the technical parameters, of the radiation unit.

It is thus desirable to overcome drawbacks described above and provide a bi-polarized broadband radiation unit of annular type with not only improved performance of various parameters of the radiation unit but also with reduced size thereof.

It is further desirable to provide a linear array antenna with such radiation unit incorporated therein.

### BRIEF SUMMARY OF THE INVENTION

The bi-polarized broadband radiation unit of annular type provided by the invention may be mounted onto a metal reflection plate to constitute a communication antenna. The bi-polarized broadband radiation unit of annular type includes two pairs of symmetric dipoles used for transmitting or receiving communication signals, a respective balun corresponding to each symmetric dipole to feed current to the symmetric dipoles in a balanced manner. Each symmetric dipole has two unit arms both of which are fixed symmetrically onto and about the balun.

According to an embodiment of the invention, each unit arm of the symmetric dipole is arc-shaped. The symmetric dipoles together may define an annular construction.

According to another embodiment of the invention, each unit arm of each symmetric dipole is configured as a straight line. The symmetric dipoles may cooperatively define an octagon.

According to yet another embodiment of the invention, each unit arm of each symmetric dipole is constructed by connecting multiple linear segments together. Thus, the symmetric dipoles may together define a construction that has at least sixteen sides which are connected to one another.

According to still another embodiment of the invention, one end of each unit arm may be coupled to a respective balun, and the other end of the unit arm may have a downwardly extended loading post formed thereon. The loading post may be a curved portion of the unit arm.

Each unit arm may have a plurality of tuning bars. The cross-sectional area of each tuning bar may be greater than the cross-sectional area of the unit arm.

A pair of symmetric dipoles of the same polarity have a pitch of between 0.4-0.6 wavelengths. The symmetric dipoles may also have a common length of 0.4-0.6 wavelengths. The polarization directions of two pairs of the symmetric dipoles may be orthogonal to each other. The baluns may each be disposed on an annular base.

Another aspect of the present invention provides a linear array antenna which includes a metal reflection plate that serves as a reflector. At least two radiation units, as described above, are positioned on the metal reflection plate for transmitting and receiving signals on a first frequency band. In addition, at least another radiation unit is positioned on the metal reflection plate and transmits and receives signals on a second frequency band. At least one of the radiation units that transmit signals on the second frequency band is installed into a space defined by the two pairs of symmetric dipoles of the radiation unit that transmits signals on the first frequency band. The radiation units of the same frequency band constitute a respective linear array antenna.

The bi-polarized broadband radiation unit of annular type provided by the invention provides a wide bandwidth, high efficiency, high isolation, high cross polarization discrimination, and low discreteness of beamwidth over changes of the frequency. Therefore, the unit can be used independently as a single antenna and, more often, as a base unit that forms an array antenna, especially a multiple community base station antenna array into which a dipole operating at a high frequency can be incorporated. Radiation performance parameters may be determined by unit performance, with the number of the units of the antenna array depending on critical condition of the antenna. Good electrical and radiation performance can be attained by suitably combining the above together.

### BRIEF DESCRIPTION OF THE DRAWINGS

FIG. 1 schematically illustrates a construction of a known radiation unit as disclosed in U.S. Pat. No. 4,434,425.

FIG. 2 schematically illustrates a construction of another known radiation unit as disclosed in U.S. Pat. No. 6,333,720 B1.

FIG. 3 shows a top plan view of a radiation unit according to a first embodiment of the invention.

FIG. 4 shows a schematic view of two pairs of symmetric dipoles which cooperatively generate bi-polarized radiation according to the first embodiment of the invention.

FIG. 5 shows a top plan view of a radiation unit according to a second embodiment of the invention.

FIG. 6 shows a side view of the radiation unit according to the second embodiment of the invention.

FIG. 7 shows a perspective view of a broadband linear array type of antenna constructed by a plurality of the radiation units of the invention.

FIG. 8 shows a perspective view of a broadband linear array type of antenna constructed by a plurality of the radiation units of the invention.

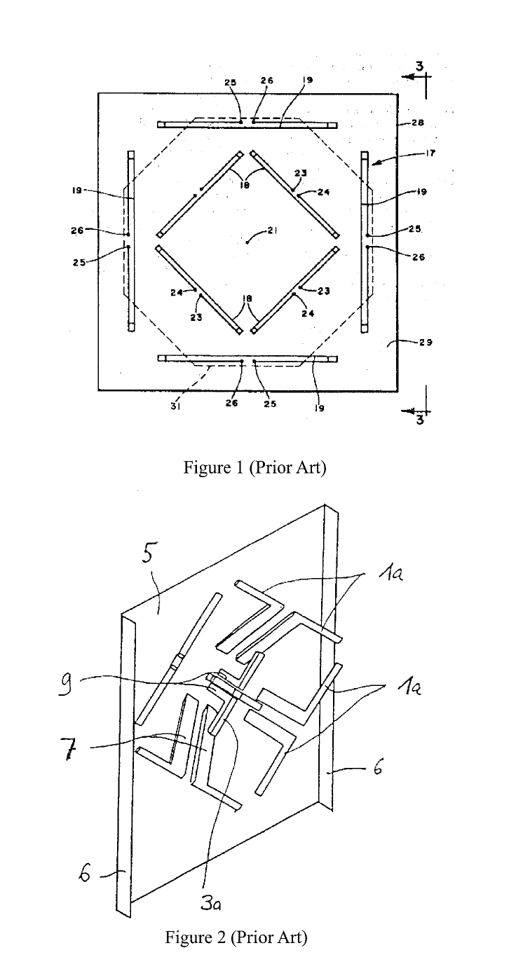

### DETAILED DESCRIPTION

The invention is described below in more detail with reference to the drawings and embodiments thereof.

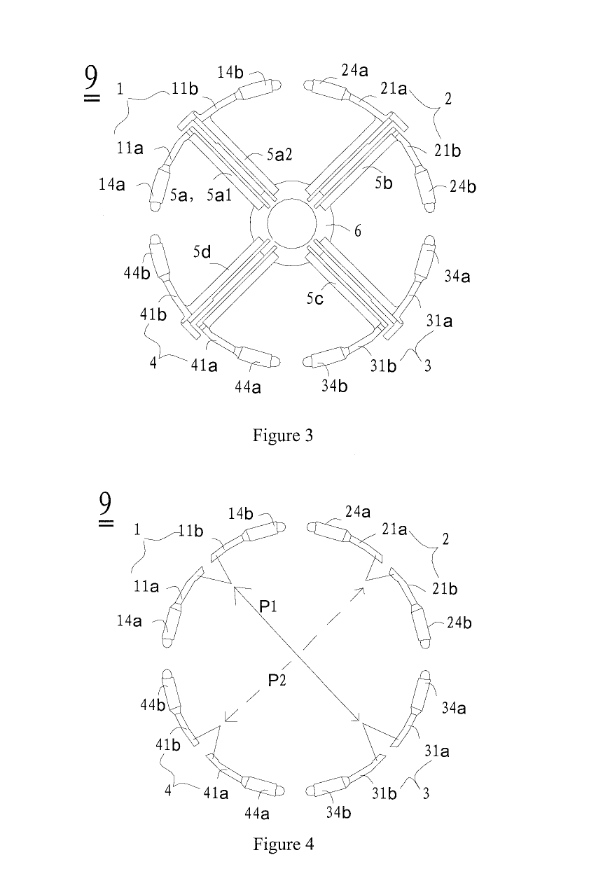

FIGS. 3 and 4 depict a first embodiment of the invention. A bi-polarized broadband radiation unit of annular type 9 includes two pairs of symmetric dipoles formed of symmetric dipoles 1, 2, 3 and 4 (four dipoles in total). The radiation unit 9 also includes four baluns 5a, 5b, 5c and 5d which are provided in correspondence with the number of symmetric dipoles. Each of the baluns 5a, 5b, 5c and 5d is fixedly placed on an annular base 6.

The symmetric dipoles 1, 2, 3, 4 are disposed on the baluns 5a, 5b, 5c and 5d, respectively. Each of the baluns 5a, 5b, 5c and 5d is supported by the annular base 6. The balun 5a, as an example, is formed of two parallel connection members 5a1 and 5a2. A line slot is defined in one of the connection members 5a1 and 5a2 for receiving electrical lines therein. The electrical lines may be used to electrically connect the balun to its corresponding symmetric dipole 1, 2, 3 and 4, thereby enabling feeding in a balanced manner. Each one of the baluns 5a-5d is connected through its two parallel connection members (for example, the connection members 5a1 and 5a2) to two unit arms of the corresponding dipole. The connection enables the dipoles 1, 2, 3, 4 to be supported in balance.

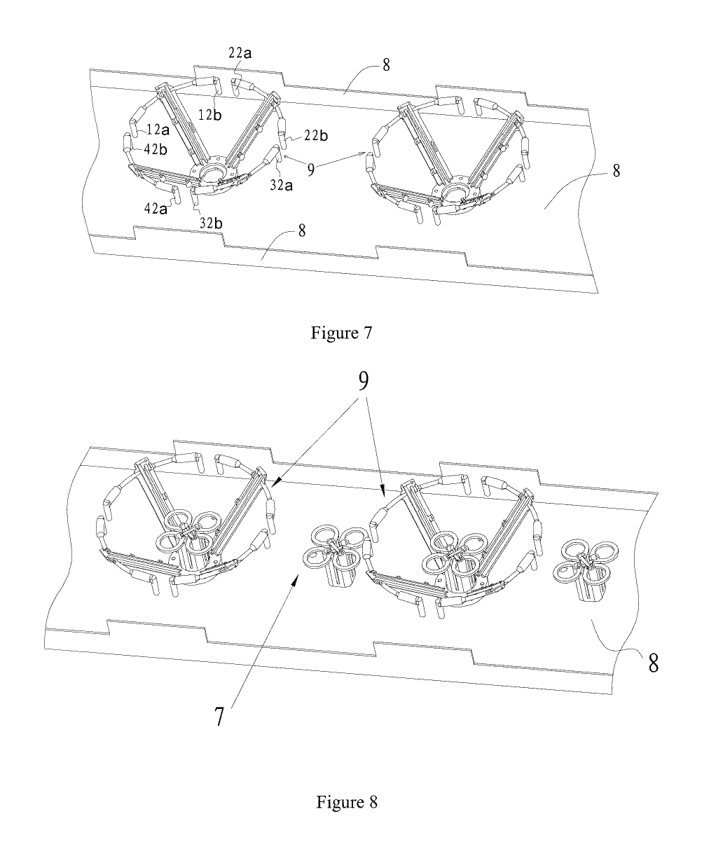

Each of symmetric dipoles 1, 2, 3, 4 has an identical construction. The symmetric dipole 1, as an example, contains two arm units 11a and 11b which are symmetric about the balun 5a. One end of each unit arm is secured to the top end of its parallel connection member, whereas the other end is bent to define a loading post 12a or 12b. A detailed structure of the loading posts is shown in FIG. 7. The loading posts may be formed as separate components and then welded onto a respective unit arm 11a or 11b. The loading posts allow for an increased a electrical length of the radiation current and a reduced orthographic projection area of the radiation unit 9 in its axial direction, thus reducing the size of the radiation unit 9, decreasing inter-coupling amongst the units, and improving radiation and electrical performance of the array antenna.

Similarly, the two unit arms 21a and 21b of the symmetric dipole 2 are connected to the balun 5b. Corresponding loading posts 22a and 22b are also provided, as shown in FIG. 7. The two unit arms 31a and 31b of the symmetric dipole 3 are connected to the balun 5c, and corresponding loading posts 32a and 32b are also provided. The two unit arms 41a and 41b of the symmetric dipole 4 are connected to the balun 5d with corresponding loading posts 42a and 42b being provided.

A distal end of each unit arm 11a (or 11b) of the symmetric dipole 1 is configured to have a tuning bar 14a (or 14b) of which the cross-sectional area is larger than that of the unit arm 11a (or 11b). The locations of the tuning bars 14a and 14b on the symmetric dipole 1, together with the size of the bars, can affect the electrical performance of the dipole 1. However, good in-band matching characteristics can be obtained by optimizing the positions and sizes of the bars 14a and 14b.

In a similar manner, the two unit arms 21a and 21b of the symmetric dipole 2 also have tuning bars 24a and 24b respectively provided thereon, the two unit arms 31a and 31b of the symmetric dipole 3 have tuning bars 34a and 34b respectively provided thereon, and the two unit arms 41a and 41b of the symmetric dipole 4 have tuning bars 44a and 44b respectively provided thereon.

FIG. 4 shows the symmetric dipoles 1 and 3 positioned opposite to one another with a pitch of about 0.4-0.6 working wavelengths. A dipole unit assembly with a polarization P1 may be defined by feeding the dipoles in parallel. Similarly, the pitch between the dipole 2 and the dipole 4 is also 0.4-0.6 wavelengths. The two dipoles 2, 4 are fed with parallel currents, thus constituting a dipole unit assembly having a polarization P2. The polarization P1 is orthogonal to the polarization P2, thus defining a bi-polarized radiation unit 9. The bi-polarized radiation unit may be formed with a polarization angle of ±45°, 0° or 90° for mobile communications according to real world requirements. A circularly polarized radiation unit may be formed when the polarization P1 has the same amplitude as the polarization P2 but has a 90° phase difference with respect to the polarization P2.

Referring back to FIGS. 3 and 4, the two unit arms 11a and 11b have a linear shape. To achieve specific advantages of the invention, however, an arc-shape is preferred. The total length of the symmetric dipole 1 is 0.4-0.6 wavelengths. The same applies to the other symmetric dipoles 2, 3, 4. As such, as shown in FIG. 2, the four symmetric dipoles of the radiation unit 9 together define a discontinuous circular arrangement having a broadband bi-polarized function.

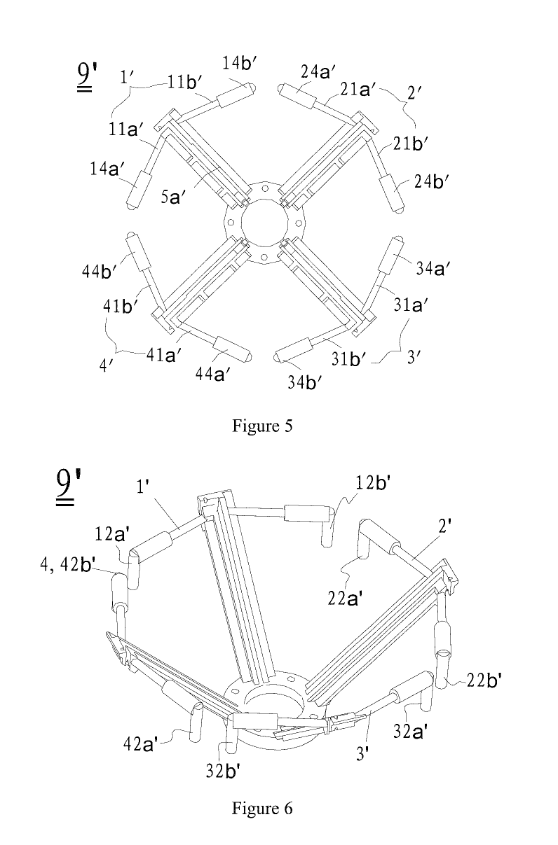

FIGS. 5 and 6 illustrate another embodiment of the invention. This embodiment has the same physical construction as the first embodiment except for the differences described herein.

The unit arms 11a′ and 11b′ of the symmetric dipole 1′ are of a linear shape. The unit arms, when installed to a balun 5a′, define an acute angle between the respective unit arm and the balun 5a′, as shown in FIG. 5. The same relation applies to the unit arms 21a′, 21b′, 21a′, to the unit arms 31b′, 31a′, 31b′, and to the unit arms 41a′, 41b′ of the symmetric dipoles 2′, 3′ and 4′, respectively, as shown in a top plan view in FIG. 5. The symmetric dipoles 1′ and 3′, 2′ and 4′ of the radiation unit 9′ together define a regular octagon.

Similar to the first embodiment, the symmetric dipoles 1′, 2′, 3′ and 4′ have corresponding tuning bars 14a′, 14b′, 24a′, 24b′, 34a′, 34b′ and 44a′, 44b′, respectively, provided thereon as illustrated in FIG. 5. The corresponding loading posts 12a′, 12b′, 22a′, 22b′, 32a′, 32b′ and 42a′, 42b′ are also provided.

Based on the design concept of the embodiment, the unit arms 11a′ and 11b′ of the symmetric dipole 1′ may be have a shape defined by multiple segments which are connected to one another in a predefined order. The same principle applies to the other symmetric dipoles 2′, 3′ and 4′. As a result, the symmetric dipoles 1′, 2′, 3′ and 4′ of the radiation unit 9′ together define a polygon having at least sixteen sides.

The radiation unit 9 shown in FIGS. 3 and 4, or alternatively the radiation unit 9′ shown in FIG. 5 or 6, may form a base station antenna of a mobile communications unit such as the linear array antenna shown in FIGS. 7 and 8.

Referring to FIG. 7, the linear array antenna includes a metal reflection plate 8 and plural radiation units 9. The radiation units 9 are seated on the metal reflection plate 8 in a linear arrangement to feed current in parallel. This type of linear array antenna is also referred to as a broadband linear array antenna.

FIG. 8 shows a dual broadband linear array antenna which is somewhat different than that of FIG. 7. This dual broadband linear array antenna is realized by disposing a plurality of high frequency radiation units 7 along the axial direction of the radiation unit 9. The radiation unit 9 may transmit and receive signals at a first frequency, whereas the radiation unit 7 may transmit and receive signals at a second frequency. At least one radiation unit 7 is incorporated into the radiation unit 9. That is, the unit 7 is located in the space defined by two pairs of symmetric dipoles of the radiation unit. The high frequency radiation unit 7, however, is not limited to the construction as shown in FIG. 8.

The radiation unit 9 of the invention is not limited to a linear array type antenna. Rather, the radiation unit may also be employed in other known antennas which employ bi-polarized radiation units.

Relative to the antenna, the metal reflection plate 8 of the invention is a critical parameter for performance. To achieve specific radiation performance, the structure of the plate should conform to the unit arms of the symmetric dipole of the radiation unit. The structure and size of the plate can be optimized using an antenna simulation.

The antenna produced according to the invention is thus simple in structure and provides good performance. Moreover, the antenna is easy to be produced, is cost-effective and is convenient to assemble.

1. A broadband radiation unit comprising:
first and second pairs of symmetric dipoles operable to transmit communication signals and to receive communication signals, the first pair of symmetric dipoles having a polarization that is orthogonal to that of the second pair of symmetric dipoles the first and second pairs of symmetric dipoles together defining an annular structure; and
A plurality of baluns that are associated with the first and second pairs of symmetric dipoles such that a given one of the plurality of baluns is associated with a respective symmetric dipole of the first and second pairs of symmetric dipoles, each one of the plurality of baluns feeding a balanced current to its associated symmetric dipole;
wherein each symmetric dipole of the first and second pairs of symmetric dipoles has two unit arms disposed on and arranged symmetrically with its associated balun.

2. The broadband radiation unit according claim 1, wherein each unit arm of the first and second pairs of symmetric dipoles is arc-shaped.

3. The broadband radiation unit according to claim 1, wherein each unit arm of the first and second pairs of symmetric dipoles defines a straight line, and symmetric dipoles of the first and second pairs of symmetric dipoles together define an octagon.

4. The broadband radiation unit according to claim 1, wherein each unit arm of the first and second pairs of symmetric dipoles is constructed of connected multiple linear segments, and the symmetric dipoles of the first and second pairs of symmetric dipoles together define a polygon having at least sixteen sides which are connected to one another.

5. The broadband radiation unit according to claim 1, wherein one end of each of the unit arms is coupled to its associated balun, and the other end thereof has a downwardly extended loading post formed thereon.

6. The broadband radiation unit according to claim 5, wherein the loading post of a given unit arm defines a curved portion of that unit arm.

7. The broadband radiation unit according to claim 1, wherein each one of the unit arms includes a plurality of tuning bars, and a cross-sectional area of each tuning bar is greater than a cross-sectional area of the unit arm.

8. The broadband radiation unit according to claim 7, wherein a given pair of symmetric dipoles of the same polarization have a pitch of 0.4-0.6 wavelengths, and the symmetric dipoles of the first and second pairs of symmetric dipoles each have a length of 0.4-0.6 wavelengths.

9. The broadband radiation unit according to claim 8, wherein the direction of polarization of the first pair of symmetric dipoles is orthogonal to the direction of polarization of the second pair of symmetric dipoles.

10. The broadband radiation unit according to claim 1, wherein each one of the plurality of baluns is disposed on an annular base.

11. A broadband linear array antenna, comprising:
a metal reflector plate; and
at least two radiation units positioned on the metal reflection plate and forming the broadband linear array antenna, each one of the at least two radiation units including:
first and second pairs of symmetric dipoles operable to transmit communication signals and to receive communication signals, the first pair of symmetric dipoles having a polarization that is orthogonal to that of the second pair of symmetric dipoles, the first and second pairs of symmetric dipoles together defining an annular structure, and
a plurality of baluns that are associated with the first and second pairs of symmetric dipoles such that a given one of the plurality of baluns is associated with a respective symmetric dipole of the first and second pairs of symmetric dipoles, each one of the plurality of baluns feeding a balanced current to its associated symmetric dipole,
wherein each symmetric dipole of the first and second pairs of symmetric dipoles has two unit arms disposed on and arranged symmetrically its associated respective balun.

12. A bi-polarized broadband community linear array antenna, comprising:
a metal reflection plate serving as a reflector;
at least two first radiation units each positioned on the metal reflection plate and operable to transmit signals in a first frequency band and to receive signals in the first frequency band, each one of the at least two first radiation units including:
first and second pairs of symmetric dipoles, the first pair of symmetric dipoles having a polarization that is orthogonal to that of the second pair of symmetric dipoles, the first and second pairs of symmetric dipoles together defining an annular structure, and
a plurality of baluns that are associated with the first and second pairs of symmetric dipoles such that a given one of the plurality of baluns is associated with a respective symmetric dipole of the first and second pairs of symmetric dipoles, each one of the plurality of baluns feeding a balanced current to its associated symmetric dipole,
wherein each symmetric dipole of the first and second pairs of symmetric dipoles has two unit arms disposed on and arranged symmetrically with its associated balun; and
at least two second radiation units located on the metal reflection plate and operable to transmit signals in a second frequency band and to receive signals in the second frequency band;
wherein a given one of the second radiation units is installed into a space defined by the first and second pairs of symmetric dipoles of a given one of the at least two first radiation units, and the radiation units that transmit signals in a given frequency band define a respective linear array antenna.
